(19) United States
(12) Patent Application Publication
(10) Pub. No.: US 2026/0095713 A1
(43) Pub. Date: Apr. 2, 2026

(54) AUDIO SIGNAL PROCESSOR

(71) Applicant: ALPS ALPINE CO., LTD., Tokyo (JP)

(72) Inventor: Tomohiko ISE, Fukushima (JP)

(21) Appl. No.: 19/214,584

(22) Filed: May 21, 2025

(30) Foreign Application Priority Data
Sep. 27, 2024 (JP) 2024-168264

(51) Int. Cl. H04S 7/00; H04R 1/40

(52) U.S. Cl. CPC H04S 7/301; H04R 1/403; H04S 2420/01

(57) ABSTRACT

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by multiplying frequencies of the separated target sound signal by a factor of k (k is an integer of 2 or more), and synthesize the source sound signal and the sound signal with enhanced sound localization for output.

### CROSS-REFERENCE TO RELATED APPLICATION

The present application is based on and claims priority to Japanese patent application No. 2024-168264 filed on September 27, 2024, with Japan Patent Office, the entire contents of which are hereby incorporated by reference.

### BACKGROUND OF THE INVENTION

### 1. Field of the Invention

The disclosures herein relate to audio signal processors.

### 2. Description of the Related Art

There is known an audio signal processor which provides sound image localization to a sound image localization target position by applying sound transmission characteristics (head-related transfer function) from a sound image localization target position to a listener’s left and right ears via convolution, and outputting an audio signal (e.g., Patent Literature (PTL) 1).

Since a human’s ability to perceive a direction of a sound with a narrow frequency band is limited, there has been a problem that sufficient sound localization cannot be provided for a sound with a narrow frequency band with the above-mentioned technology that applies the sound transmission characteristics (head-related transfer function) via convolution and outputs the audio signal.

Therefore, the present disclosure provides an audio signal processing device that can achieve better sound localization for a sound with a narrow frequency band.

### CITATION LIST

### PATENT LITERATURE

[PTL 1] Japanese Patent No. 3395809

### SUMMARY OF THE INVENTION

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by multiplying frequencies of the separated target sound signal by a factor of k (k is an integer of 2 or more), and synthesize the source sound signal and the sound signal with enhanced sound localization for output.

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by multiplying frequencies of the separated target sound signal by a factor of 1/L (L is an integer of 2 or more), and synthesize the source sound signal and the sound signal with enhanced sound localization for output.

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by synthesizing a first signal, which is generated by multiplying frequencies of the separated target sound signal by a factor of k (k is an integer of 2 or more), and a second signal, which is generated by multiplying frequencies of the separated target sound signal by a factor of 1/L (L is an integer of 2 or more), and synthesize the source sound signal and the sound signal with enhanced sound localization for output.

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization, for each integer i from 2 to n (n > 2), by multiplying a frequency of the target sound signal separated by the target sound separation unit by i to generate signals, and synthesizing the generated signals to generate a sound signal with enhanced sound localization, and synthesize the source sound signal and the sound signal with enhanced sound localization for output.

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization, for each integer j from 2 to m (m > 2), by multiplying a frequency of the target sound signal separated by the target sound separation unit by 1/j to generate signals, and synthesizing the generated signals to generate a sound signal with enhanced sound localization, and synthesize the source sound signal and the sound signal with enhanced sound localization for output.

An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by synthesizing a first signal, which is generated by multiplying a frequency of the target sound signal separated by the target sound separation unit by i, for each integer i from 2 to n (n > 2), and a second signal, which is generated by multiplying the frequency of the target sound signal separated by the target sound separation unit by 1/j, for each integer j from 2 to m (m > 2), and synthesize the source sound signal and the sound signal with enhanced sound localization for output.

In the above audio signal processor, each of the signal processing circuits is further configured to extend a duration of the sound signal with enhanced sound localization before being synthesized when a duration of the separated target sound signal is shorter than a predetermined time length.

The above audio signal processing unit may include a direction estimation circuit configured to estimate a direction in which the target sound is to be localized, wherein each of the signal processing circuits is further configured to apply a head-related transfer function to the sound signal with enhanced sound localization before being synthesized, the head-related transfer function conforming to the estimated direction, and replace the target sound signal in the source sound signal with a signal obtained by applying the head-related transfer function to the target sound signal.

In this case, the direction estimation circuit may estimate the direction in which the target sound is to be localized, based on a relationship between target sound signals separated by the signal processing circuits.

Alternatively, the direction estimation circuit may estimate the direction in which the target sound is to be localized, based on information that indicates a position of a sound source of the target sound and that is output from a device that outputs audio signals of the audio signal channels.

According to the above audio signal processor, the frequency band of the sound associated with the target sound can be expanded by adding harmonics and subharmonics to the target sound having poor localization feeling due to the narrow frequency band, which results in better sound localization.

As described above, according to the present disclosure, it is possible to provide an audio signal processor capable of achieving better sound localization for a sound with a narrow frequency band.

### BRIEF DESCRIPTION OF THE DRAWINGS

FIG. 1 is a drawing illustrating a configuration of an AV system according to an embodiment of the present disclosure;

FIG. 2 is a drawing illustrating a configuration of an audio signal processor according to the embodiment of the present disclosure;

FIG. 3 is a drawing illustrating a configuration of a component with an enhanced sound localization generation unit according to an embodiment of the present disclosure;

FIG. 4 is a drawing illustrating another configuration example of the component with enhanced sound localization generation unit according to the embodiment of the present disclosure;

FIG. 5 is a drawing illustrating yet another configuration example of the component with enhanced sound localization generation unit according to the embodiment of the present disclosure;

FIG. 6A is a drawing illustrating a configuration of a target sound separation unit according to the embodiment of the present disclosure;

FIG. 6B is a drawing illustrating a configuration of a band-pass filter used as a target sound separation unit according to the embodiment of the present disclosure;

FIG. 7 is a drawing illustrating another configuration example of the audio signal processor according to the embodiment of the present disclosure;

FIG. 8 is a drawing illustrating yet another configuration example of the audio signal processor according to the embodiment of the present disclosure;

FIG. 9A is a drawing illustrating an example of an image of a game program; and

FIG. 9B is a drawing illustrating another configuration example of the audio signal processor in a case of FIG. 9A.

### DESCRIPTION OF THE PREFERRED EMBODIMENTS

In the following, embodiments of the present invention will be described.

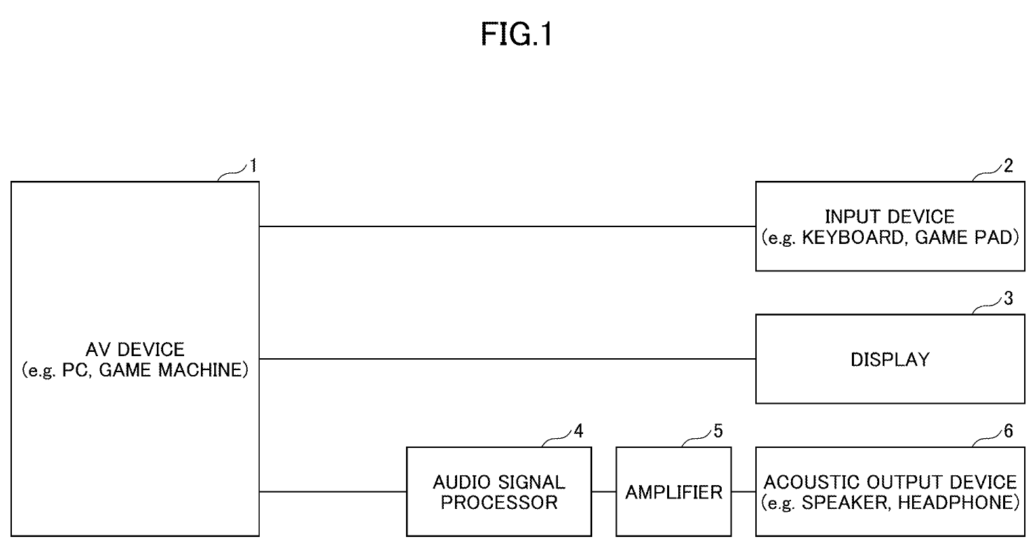

FIG. 1 is a drawing illustrating a configuration of an AV system according to the present embodiment.

As shown in the figure, the AV system includes an AV device 1 for outputting a video signal and an audio signal of the same AV content, an input device 2 for receiving operations for the AV device 1, a display 3 for displaying the video signal output by the AV device 1, an audio signal processor 4 for outputting the audio signal output by the AV device 1 after performing signal processing to enhance localization of a sound targeted for enhanced sound localization, an amplifier 5 for amplifying the audio signal output by the signal with enhanced sound localization, and an acoustic output device 6 for emitting the sound represented by the audio signal output by the amplifier 5.

The AV device 1 is, for example, a PC or a game machine, the input device 2 is, for example, a keyboard or a game pad, and the acoustic output device 6 is, for example, a speaker or a headphone.

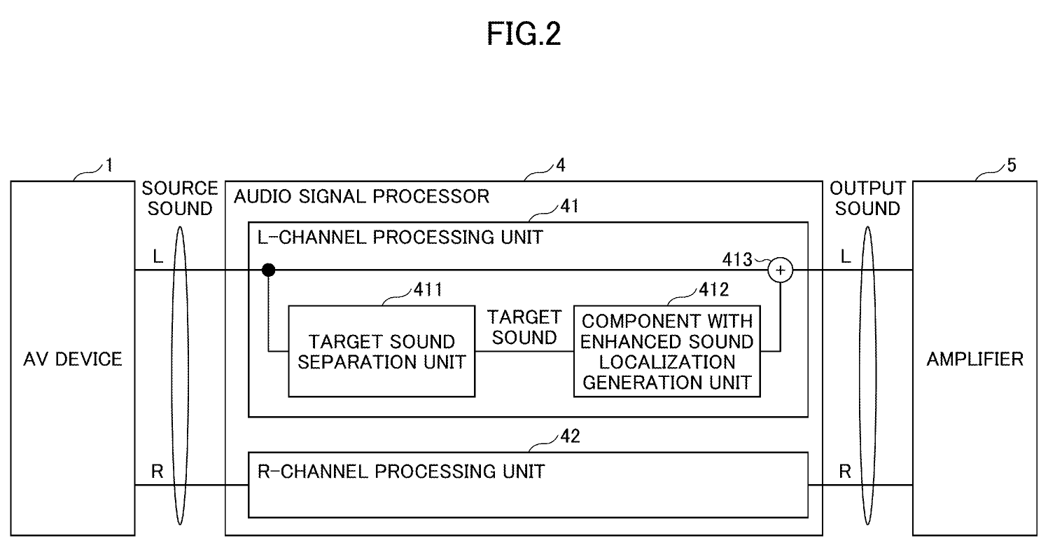

Next, FIG. 2 is a drawing illustrating a configuration of the audio signal processor 4.

As shown in the figure, the AV device 1 outputs stereo audio signals of two channels, an L-channel and an R-channel, as source sounds. The audio signal processor 4 outputs the stereo audio signals of the two channels, the L-channel and the R-channel, to the amplifier 5 as output sounds.

The audio signal processor 4 is provided with an L-channel processing unit 41 which performs signal processing on the audio signal of the L-channel of the source sounds and outputs it to the amplifier 5 as the audio signal of the L-channel of the output sounds, and an R-channel processing unit 42 which performs signal processing on the audio signal of the R-channel of the source sounds and outputs it to the amplifier 5 as the audio signal of the R-channel of the output sounds.

The L-channel processing unit 41 and the R-channel processing unit 42 have the same structure. As shown in FIG. 2 for the L-channel processing unit 41, the L-channel is a channel corresponding to the L-channel processing unit 41 and the R-channel is a channel corresponding to the R-channel processing unit 42, and each includes a target sound separation unit 411 for separating a target sound, which is a sound to be processed for enhanced sound localization, from an audio signal of a corresponding channel of the source sound, a component with enhanced sound localization generation unit 412 for generating an audio signal component for enhancing the localization of the target sound from the target sound input from the target sound separation unit 411 as a component with enhanced sound localization, and an addition unit 413 for synthesizing the component with enhanced sound localization generated by the component with enhanced sound localization generation unit 412 with the audio signal of a corresponding channel of the source sound by addition, and outputting the synthesized component as an audio signal of a corresponding channel of the output sound.

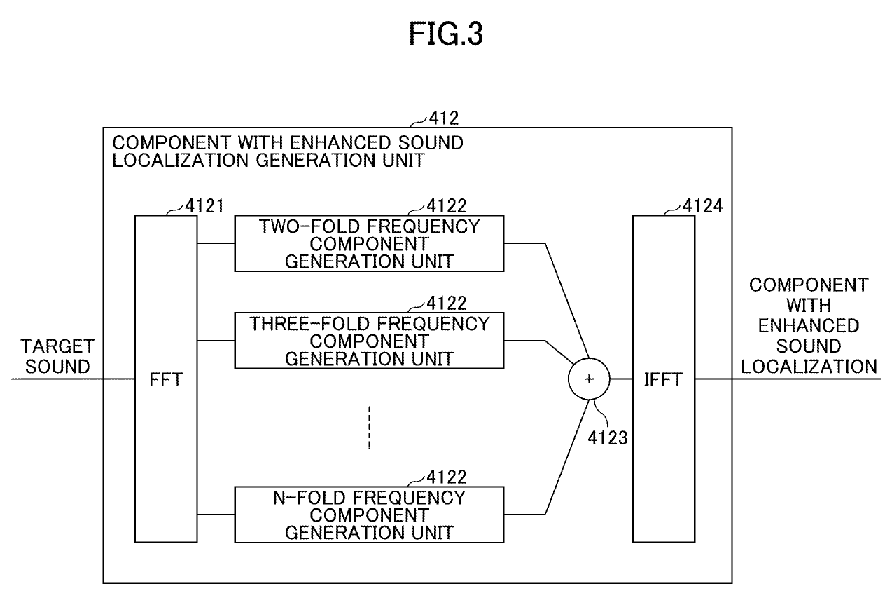

Next, FIG. 3 is a drawing illustrating a configuration of a component with enhanced sound localization generation unit 412 of the audio signal processor 4.

The configuration shown in FIG. 3 is that of a component with enhanced sound localization generation unit 412, which is used when the target sound is concentrated in a low-frequency band (e.g., a band of 100 Hz or less), that is, when the target sound’s frequency band generally falls within the low-frequency band.

The sound concentrated in the low-frequency band includes, for example, footsteps of an enemy when playing an FPS (first person shooting) game or a TPS (third person shooting) game with the AV device 1. It is preferable that sound localization of such footsteps be enhanced as a target sound so that the position and movement of the enemy can be perceived through hearing.

As shown in the figure, the component with enhanced sound localization generation unit 412 includes an FFT 4121 that converts an input target sound into a signal in the frequency domain by Fast Fourier Transformation.

The component with enhanced sound localization generation unit 412 also includes a number of N - 1 of i-fold frequency component generation units 4122, where i is an integer between 2 and N (N ≥ 2), and the i-fold frequency component generation unit 4122 generates a signal in the frequency domain in which each frequency component of the target sound is converted into a component in the frequency of the i-fold frequency with a predetermined gain from the output of the FFT 4121. Therefore, the i-fold frequency component generation unit 4122 generates a signal in the frequency domain of an (i - 1)th harmonic for each frequency component of the target sound.

It also includes a frequency domain addition unit 4123 that generates a signal in the frequency domain that is synthesized by adding each frequency component of the signal in the frequency domain generated by the number of N - 1 of i-fold frequency component generation units 4122 for each frequency, and an IFFT 4124 that converts (returns) the signal in the frequency domain generated by the frequency domain addition unit 4123 into an audio signal in a time domain by Inverse Fast Fourier Transformation. The audio signal in the time domain output by the IFFT 4124 becomes the component with enhanced sound localization output by the component with enhanced sound localization generation unit 412.

Here, a predetermined gain used when the i-fold frequency component generation unit 4122 generates a signal in the frequency domain in which each frequency component of the target sound is converted into a component in the frequency of the i-fold frequency is set so that the sound component corresponding to the signal in the frequency domain does not sound unnatural in the sound output from the acoustic output device 6.

Here, the component with enhanced sound localization generation unit 412 may include one i-fold frequency component generation unit 4122, where i is an integer of 2 or more.

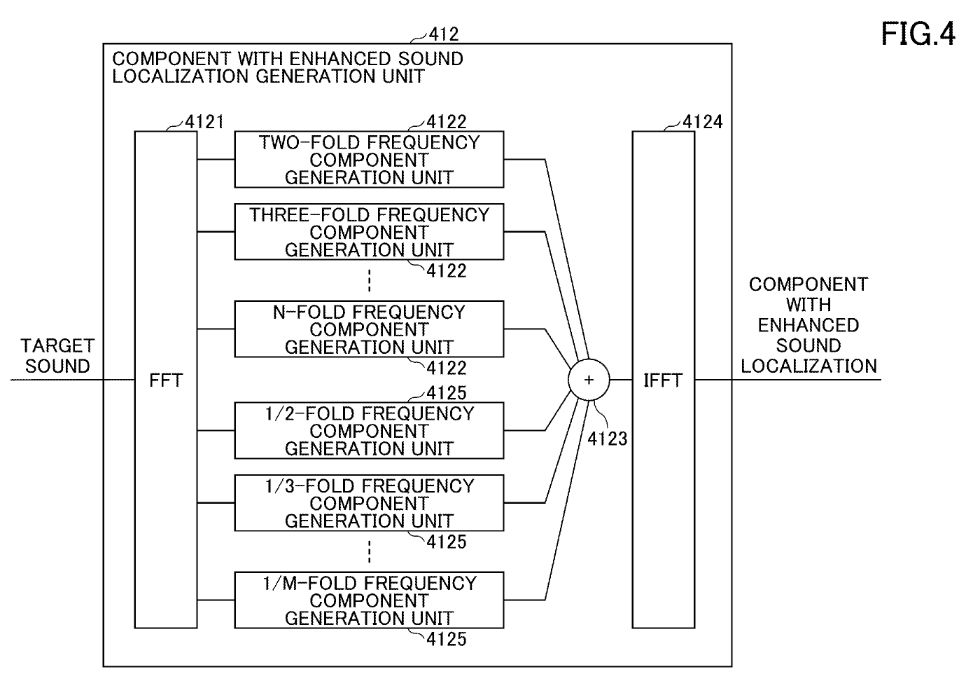

Although the configuration of the component with enhanced sound localization generation unit 412 has been described above, if the target sound is concentrated in a narrow band in a middle frequency range (800 Hz to 2 kHz), the component with enhanced sound localization generation unit 412 may be configured as shown in FIG. 4.

As shown in this figure, the component with enhanced sound localization generation unit 412 has a number of M - 1 of 1/j-fold frequency component generation units 4125, where j is an integer between 2 and M (M ≥ 2), in addition to the configuration shown in FIG. 3, and the 1/j-fold frequency component generation unit 4125 generates a signal in a frequency domain in which components of each frequency of the target sound are converted into components of a frequency that is 1/j times the frequency with a predetermined gain from the output of the FFT 4121. Therefore, the 1/j-fold frequency component generation unit 4125 generates a signal in the frequency domain of the (j - 1)th subharmonic for each frequency component of the target sound.

In addition, in this configuration, the frequency domain addition unit 4123 generates a signal in a frequency domain in which components of each frequency of the signals in the frequency domain generated by the number of (N – 1) of i-fold frequency component generation units 4122 and components of each frequency of the signals in the frequency domain generated by the number of (M – 1) of 1/j-fold frequency component generation units 4125 are synthesized by addition each frequency, and outputs the resultant signal to the IFFT 4124.

Then, the IFFT 4124 converts the signal in the frequency domain generated by the frequency domain addition unit 4123 into an audio signal in the time domain and outputs the audio signal as a component with enhanced sound localizations.

Here, the predetermined gain used when the 1/j-fold frequency component generation unit 4125 generates a signal in the frequency domain in which components of each frequency of the target sound are converted into 1/j multiplication frequency components is set so that the sound components corresponding to the signals in the frequency domain do not sound unnatural in the sound output from the acoustic output device 6.

Here, the component with enhanced sound localization generation unit 412 may include, as the i-fold frequency component generation unit 4122, one i-fold frequency component generation unit 4122 where i is one integer of 2 or more. It may also include, as the 1/j-fold frequency component generation unit 4125, one 1/j-fold frequency component generation unit 4125 where j is one integer of 2 or more.

According to the above configuration, it is possible to provide better sound localization by expanding the frequency band of the sound associated with the target sound by adding harmonics or subharmonics to the target sound which has poor localization due to the narrow frequency band.

Next, in the application where the target sound may be a short (e.g., 20 ms or less) sound in time, a configuration for time-stretching the component with enhanced sound localization may be added to the component with enhanced sound localization generation unit 412 shown in FIGS. 3 and 4. Here, the time stretching is a signal processing for extending the duration without changing pitch of the sound.

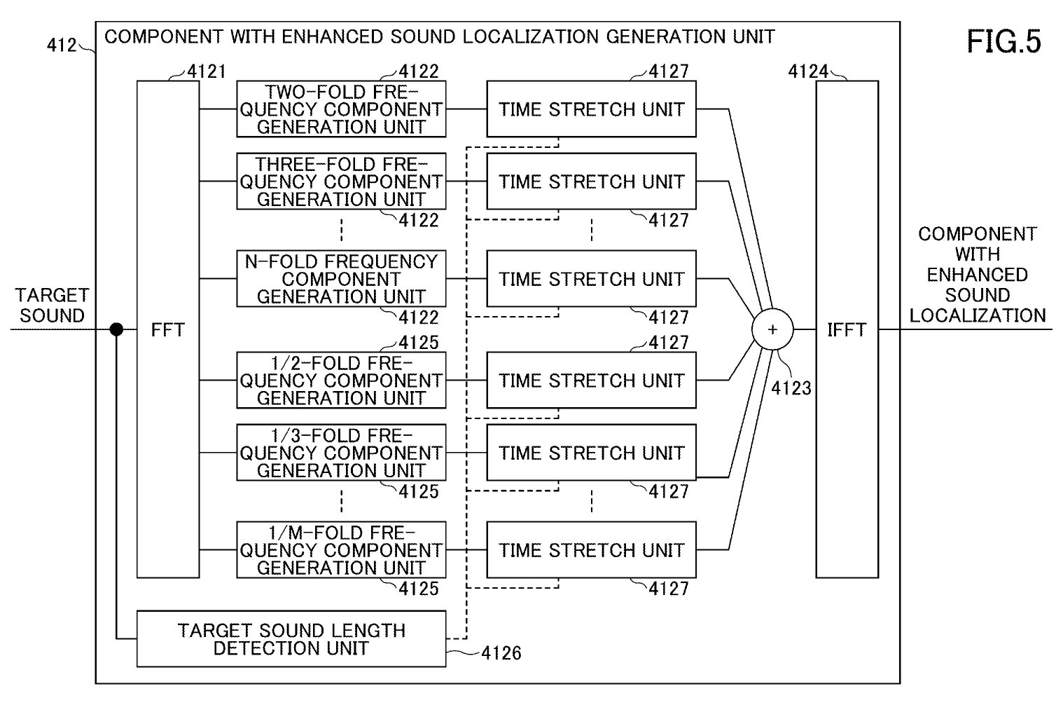

That is, in this case, as shown in FIG. 5 when a configuration for time-stretching the component with enhanced sound localization is added to the component with enhanced sound localization generation unit 412 shown in FIG. 4, the component with enhanced sound localization generation unit 412 is provided with a target sound length detection unit 4126 for detecting the time length of the target sound.

Here, a target sound length detection unit 4126 detects the time length of the target sound from the target sound. However, the target sound length detection unit 4126 may detect the time length of the target sound from a signal in the frequency domain output by the FFT 4121.

Also, a time stretch unit 4127 for outputting the time length of the signal in the frequency domain of the target sound obtained by converting the frequencies output by the i-fold frequency component generation unit 4122 and the 1/j-fold frequency component generation unit 4125 to i times or 1/j times to the frequency domain addition unit 4123 by extending the duration to a predetermined time (e.g., 20 ms) or more without changing the pitch (frequency) is provided corresponding to each of the i-fold frequency component generation units 4122 and the 1/j-fold frequency component generation units 4125.

Then, when the target sound length detection unit 4126 detects that the target sound is shorter than the predetermined time length (e.g., 20 ms or less), each time stretch unit 4127 extends the duration of the signal in the frequency region of the target sound whose frequency has been converted into i times or 1/j times to a time longer than the predetermined time (e.g., a predetermined time of 20 ms or more) without changing the pitch.

When the time length of the target sound is always shorter than the predetermined time length, the target sound length detection unit 4126 detects the target sound, and in response to the detection, each time stretch unit 4127 may extend the duration of the signal in the frequency region of the target sound whose frequency has been converted into i times or 1/j times to a time longer than the predetermined time without changing the pitch.

Thus, by performing the time stretch, even when the duration of the target sound is so short that the sound cannot be stably detected, the target sound localization can be provided.

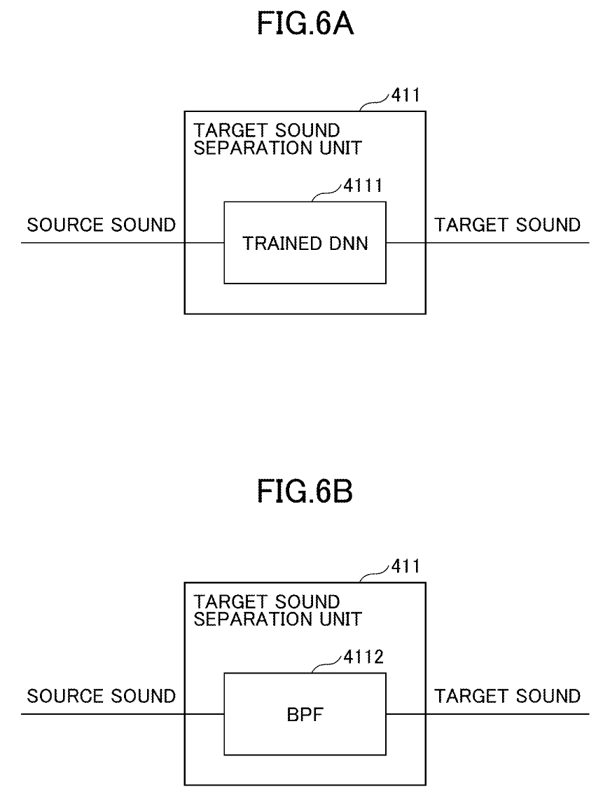

Next, FIG. 6A is a drawing illustrating a configuration of a target sound separation unit 411 of the audio signal processor 4.

As shown in the figure, a DNN (Deep Neural Network) 4111 which has been subjected to deep learning so as to extract the target sound from the audio signal can be used as the target sound separation unit 411.

When the frequency band of the target sound does not substantially overlap the frequency band of other sounds in the source sound, as shown in FIG. 6B, a BPF (Band-Pass Filter) 4112 may be used as the target sound separation unit 411 to extract a sound in the frequency band of the target sound.

The embodiments of the present invention have been described above.

In the above-described embodiments, the head-related transfer function may be further applied to the audio signal processor 4.

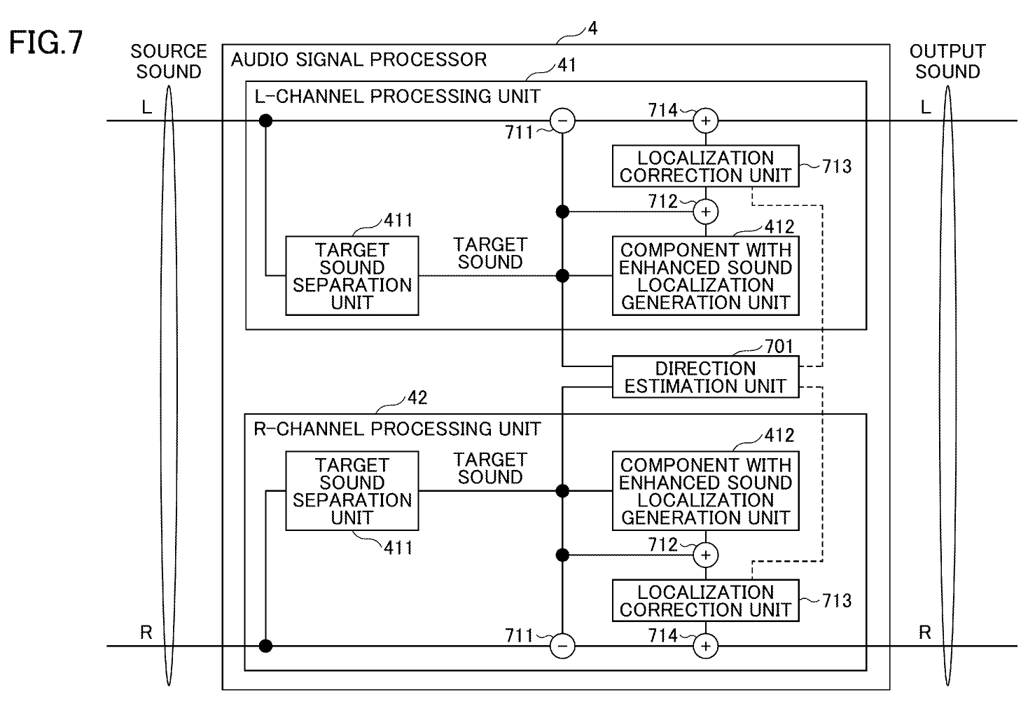

FIG. 7 is a drawing illustrating another configuration example of the audio signal processor 4 in this case.

As shown in the figure, the audio signal processor 4 includes an L-channel processing unit 41, an R-channel processing unit 42, and a direction estimation unit 701.

The L-channel processing unit 41 and the R-channel processing unit 42 have the same structure and are provided with a target sound separation unit 411 for separating the target sound from the audio signal of the corresponding channel of the source sound as described above, a component with enhanced sound localization generation unit 412 for generating a component with enhanced sound localization from the target sound output by the target sound separation unit 411 as described above, a target sound subtractor 711 for subtracting the target sound output by the target sound separation unit 411 from the audio signal of the corresponding channel of the source sound, a target sound adder 712 for synthesizing the output of the component with enhanced sound localization generation unit 412 and the target sound output by the target sound separation unit 411 by addition, a localization correction unit 713 for convolving the head-related transfer function into the output of the target sound adder 712, and an output adder 714 for synthesizing the output of the localization correction unit 713 and the output of the target sound subtractor 711 and outputting the synthesized signal as the audio signal of the corresponding channel of the output sound by addition.

The direction estimation unit 701 estimates the direction of the target sound source represented by the source sound to the listener as the localization direction of the sound image of the target sound from a ratio of a volume level between the target sound output by the target sound separation unit 411 of the L-channel processing unit 41 and the target sound output by the target sound separation unit 411 of the R-channel processing unit 42 and the time delay.

The head-related transfer function convolved by the localization correction unit 713 of the L-channel processing unit 41 represents a head-related transfer function from the target sound source to the listener’s left ear, where a distance to the target sound source is a predetermined distance, and the direction of the target sound source is found as the estimated localization direction. Moreover, the head-related transfer function convolved by the localization correction unit 713 of the R-channel processing unit 42 represents a head-related transfer function from the target sound source to the listener’s right ear, where the distance to the target sound source is a predetermined distance, and the direction of the target sound source is found as the estimated localization direction.

Therefore, each of the outputs of the L-channel processing unit 41 and the R-channel processing unit 42 is an output in which the component other than the target sound of the audio signal of the corresponding channel of the source sound and the component obtained by convolving the head-related transfer function with the target sound and the component with enhanced sound localization generated from the target sound are synthesized by addition.

Therefore, the configuration shown in FIG. 7 is equivalent to the configuration of the audio signal processor 4 shown in FIG. 2 in which the component with enhanced sound localization added by an addition unit 413 is replaced with the component obtained by convolving the head-related transfer function with the component with enhanced sound localization, and the target sound in the source sound added by the addition unit 413 is replaced with the sound obtained by convolving the head-related transfer function with the target sound.

When the target sound included in the source sound is a sound in which the head-related transfer function has already been convolved, the head-related transfer function convolved by the localization correction unit 713 of the L-channel processing unit 41 or the R-channel processing unit 42 may be set so that the head-related transfer function convolved in the output of the localization correction unit 713 becomes an appropriate head-related transfer function for the localization position direction estimated by the direction estimation unit 701 in consideration of this already convolved head-related transfer function.

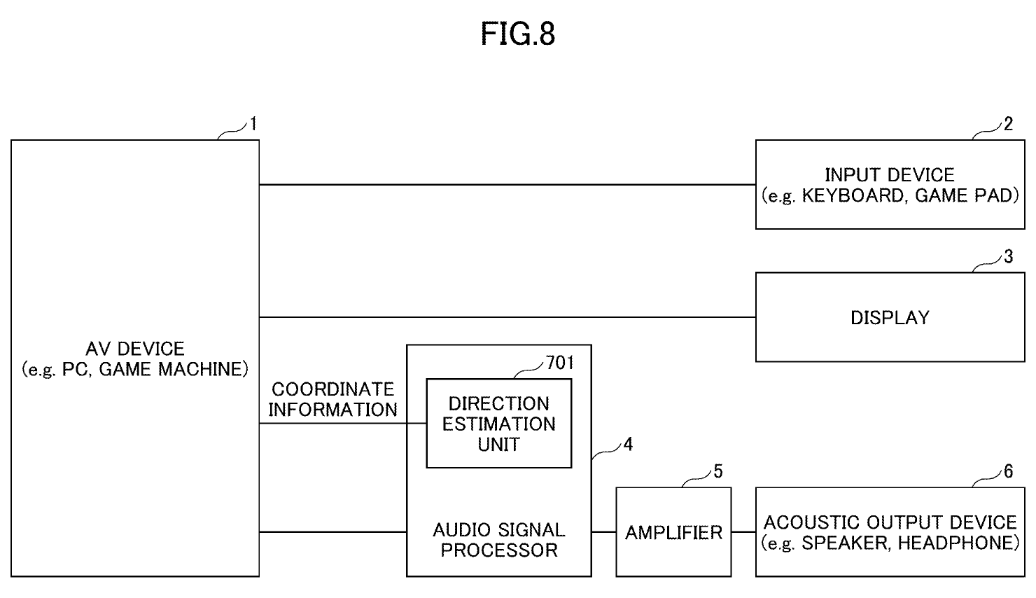

When the target sound is footsteps or shooting sound of an enemy in an FPS (first-person shooting) game or a TPS (third-person shooting) game, and coordinate information of the enemy to the player in the game space can be obtained from the AV device 1 executing the game program, the direction estimation unit 701 of the audio signal processor 4 shown in FIG. 7 may be replaced with a direction estimation unit 701 which estimates the direction of the enemy to the player in the game space as the localization position direction of the sound image of the target sound based on the coordinate information of the enemy to the player in the game space obtained from the AV device 1, as shown in FIG. 8.

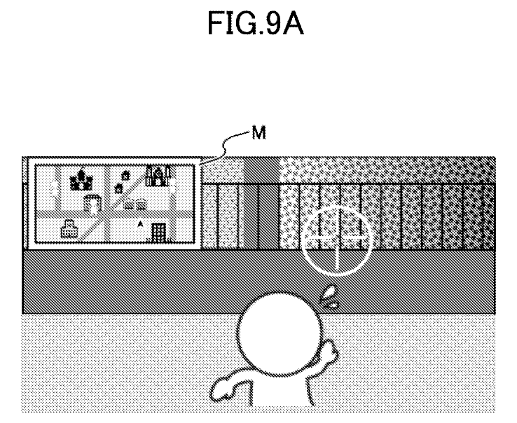

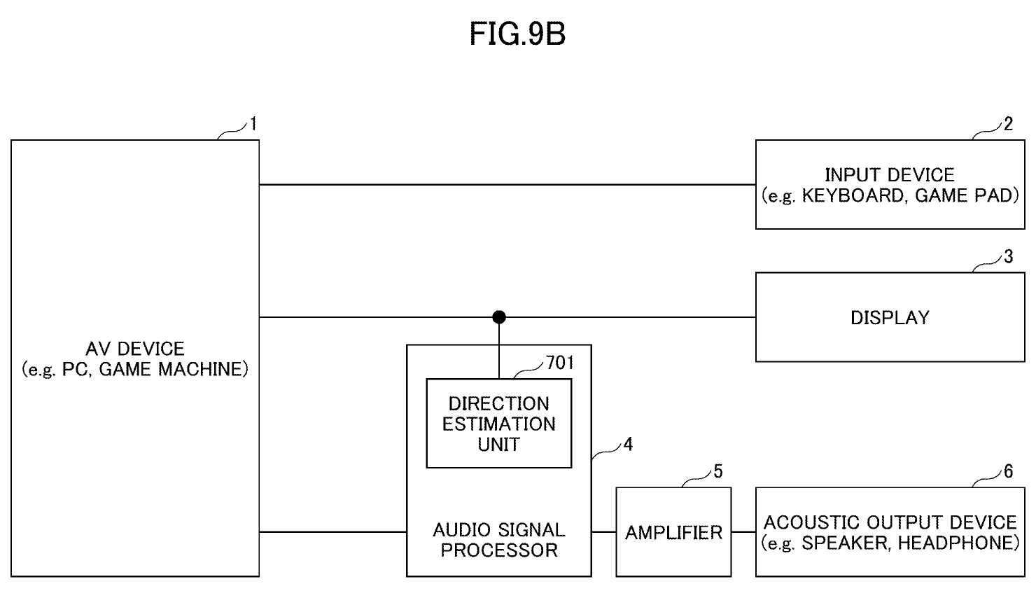

When the target sound is footsteps or shooting sound of an enemy in an FPS (first-person shooting) game or a TPS (third-person shooting) game, and the AV device 1 executing the game program displays a map image M showing the positions of the player and the enemy on the map of the game space on the display 3, as shown in FIG. 9A, the direction estimation unit 701 of the audio signal processor 4 shown in FIG. 7 may be replaced with a direction estimation unit 701 which analyzes the video output by the AV device 1 to determine the direction of the enemy to the player in the game space, and estimates the obtained direction as the localization position direction of the sound image of the target sound, as shown in FIG. 9B.

Thus, it can be expected that a better sound localization can be given by estimating an orientation position direction of the sound image of the target sound and convolving the head-related transfer function appropriate for the orientation position direction estimated by the direction estimation unit 701 into an orientation sensation enhancing component and the target sound.

Although the case where the AV device 1 outputs the stereo audio signals of two channels of the L-channel and the R-channel as the source sound has been described above, the present embodiment can be similarly applied to the case where the AV device 1 outputs the audio signals of three or more channels as the source sound by providing the same processing unit as the L-channel processing unit 41 and the R-channel processing unit 42 for each channel.

As is naturally recognized by a person having ordinary skill in the art, the audio signal processor and its signal processing units are electronic circuits. For example, the audio signal processor and its signal processing units may be dedicated circuits such as application specific integrated circuits (ASIC), field programable gate arrays (FPGA), central processing units (CPU), or digital signal processors (DSP).

1. An audio signal processor including signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by multiplying frequencies of the separated target sound signal by a factor of k (k is an integer of 2 or more), and synthesize the source sound signal and the sound signal with enhanced sound localization for output.

2. An audio signal processor including signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by multiplying frequencies of the separated target sound signal by a factor of 1/L (L is an integer of 2 or more), and synthesize the source sound signal and the sound signal with enhanced sound localization for output.

3. An audio signal processor including signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by synthesizing a first signal, which is generated by multiplying frequencies of the separated target sound signal by a factor of k (k is an integer of 2 or more), and a second signal, which is generated by multiplying frequencies of the separated target sound signal by a factor of 1/L (L is an integer of 2 or more), and synthesize the source sound signal and the sound signal with enhanced sound localization for output.

4. An audio signal processor including signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization, for each integer i from 2 to n (n > 2), by multiplying a frequency of the target sound signal separated by the target sound separation unit 411 by i to generate signals, and synthesizing the generated signals to generate a sound signal with enhanced sound localization, and synthesize the source sound signal and the sound signal with enhanced sound localization for output.

5. An audio signal processor includes signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization, for each integer j from 2 to m (m > 2), by multiplying a frequency of the target sound signal separated by the target sound separation unit 411 by 1/j to generate signals, and synthesizing the generated signals to generate a sound signal with enhanced sound localization, and synthesize the source sound signal and the sound signal with enhanced sound localization for output.

6. An audio signal processor including signal processing circuits provided in one-to-one correspondence with audio signal channels, wherein each of the signal processing circuits is configured to separate, from a source sound signal, a target sound signal representing a target sound, which is to be processed for enhanced sound localization, the source sound signal being an audio signal of a corresponding channel, generate a sound signal with enhanced sound localization by synthesizing a first signal, which is generated by multiplying a frequency of the target sound signal separated by the target sound separation unit 411 by i, for each integer i from 2 to n (n > 2), and a second signal, which is generated by multiplying the frequency of the target sound signal separated by the target sound separation unit 411 by 1/j, for each integer j from 2 to m (m > 2), and synthesize the source sound signal and the sound signal with enhanced sound localization for output.

7. The audio signal processor according to according to any one of clauses 1 to 6, wherein each of the signal processing circuits is further configured to extend a duration of the sound signal with enhanced sound localization before being synthesized when a duration of the separated target sound signal is shorter than a predetermined time length.

8. The audio signal processing unit according to any one of clauses 1 to 7, further including a direction estimation circuit configured to estimate a direction in which the target sound is to be localized, wherein each of the signal processing circuits is further configured to apply a head-related transfer function to the sound signal with enhanced sound localization before being synthesized, the head-related transfer function conforming to the estimated direction, and replace the target sound signal in the source sound signal with a signal obtained by applying the head-related transfer function to the target sound signal.

9. The audio signal processor according to clause 8, wherein the direction estimation circuit is configured to estimate the direction in which the target sound is to be localized, based on a relationship between target sound signals separated by the signal processing circuits.

10. The audio signal processor according to clause 8, wherein the direction estimation circuit is configured to estimate the direction in which the target sound is to be localized, based on information that indicates a position of a sound source of the target sound and that is output from a device that outputs audio signals of the audio signal channels.

What is claimed is:

1. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization by multiplying frequencies of the separated target sound signal by a factor of k (k is an integer of 2 or more); and
synthesize the source sound signal and the sound signal with enhanced sound localization for output.

2. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization by multiplying frequencies of the separated target sound signal by a factor of 1/L (L is an integer of 2 or more); and
synthesize the source sound signal and the sound signal with enhanced sound localization for output.

3. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization by synthesizing a first signal, which is generated by multiplying frequencies of the separated target sound signal by a factor of k (k is an integer of 2 or more), and a second signal, which is generated by multiplying frequencies of the separated target sound signal by a factor of 1/L (L is an integer of 2 or more); and
synthesize the source sound signal and the sound signal with enhanced sound localization for output.

4. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization, for each integer i from 2 to n (n > 2), by multiplying a frequency of the target sound signal separated by the target sound separation unit by i to generate signals, and synthesizing the generated signals to generate a sound signal with enhanced sound localization; and
synthesize the source sound signal and the sound signal with enhanced sound localization for output.

5. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization, for each integer j from 2 to m (m > 2), by multiplying a frequency of the target sound signal separated by the target sound separation unit by 1/j to generate signals, and synthesizing the generated signals to generate a sound signal with enhanced sound localization; and
synthesize the source sound signal and the sound signal with enhanced sound localization for output.

6. An audio signal processor comprising signal processing circuits provided in one-to-one correspondence with audio signal channels, wherein each of the signal processing circuits is configured to:
separate, from a source sound signal, a target sound signal representing a target sound, which is to be processed for enhanced sound localization, the source sound signal being an audio signal of a corresponding channel;
generate a sound signal with enhanced sound localization by synthesizing a first signal, which is generated by multiplying a frequency of the target sound signal separated by the target sound separation unit by i, for each integer i from 2 to n (n > 2), and a second signal, which is generated by multiplying the frequency of the target sound signal separated by the target sound separation unit by 1/j, for each integer j from 2 to m (m > 2); and
synthesize the source sound signal and the sound signal with enhanced sound localization for output.

7. The audio signal processor according to claim 1, wherein each of the signal processing circuits is further configured to extend a duration of the sound signal with enhanced sound localization before being synthesized when a duration of the separated target sound signal is shorter than a predetermined time length.

8. The audio signal processor according to claim 1, further comprising a direction estimation circuit configured to estimate a direction in which the target sound is to be localized, wherein each of the signal processing circuits is further configured to apply a head-related transfer function to the sound signal with enhanced sound localization before being synthesized, the head-related transfer function conforming to the estimated direction, and replace the target sound signal in the source sound signal with a signal obtained by applying the head-related transfer function to the target sound signal.

9. The audio signal processor according to claim 8, wherein the direction estimation circuit is configured to estimate the direction in which the target sound is to be localized, based on a relationship between target sound signals separated by the signal processing circuits.

10. The audio signal processor according to claim 8, wherein the direction estimation circuit is configured to estimate the direction in which the target sound is to be localized, based on information that indicates a position of a sound source of the target sound and that is output from a device that outputs audio signals of the audio signal channels.
